(19) United States
(12) Patent Application Publication
(10) Pub. No.: US 2006/0227085 A1
(43) Pub. Date: Oct. 12, 2006

(54) Led illumination source/display with individual led brightness monitoring capability and calibration method

(76) Inventors: Norton K. Boldt JR., Lake Forest, CA (US); Curt Deckert, Santa Ana, CA (US); James C. Johnson, Santa Ana, CA (US); Andrew I. Lisiecki, Irvine, CA (US)

Correspondence Address: Harold L Jackson;Jackson Law Corporation, Suite N, 14751 Plaza Drive, Tustin, CA, 92780, US

(21) Appl. No.: 10/551,204

(22) PCT Filed: Apr. 20, 2004
(86) PCT No.: PCT/US04/12122

§ 371 Date: Sep. 23, 2005

Related U.S. Application Data
(60) Provisional application No. 60/465,437, filed on Apr. 25, 2003.

(51) Int. Cl. G09G 3/32

(52) U.S. Cl. 345/83

(57) ABSTRACT

An LED area illumination source/display (10) such as an electronic billboard is made up of a number of individual pixels with each pixel including a number of LEDs, e.g., a red (18), blue (19) and green LED (20), with each LED representing a primary color being arranged to be energized separately. At least one light sensor (22) is incorporated into the display for providing a measure of the light emitted from each LED representing a primary color in each pixel. The source/display (10) is susceptible of being self-calibrated by initially energizing the LEDs (18, 19, 20) at less than a maximum level and increasing the energization level as necessary during use to restore the original light output of degraded LEDs.

### RELATED APPLICATION

This application is based on U.S. Provisional Application Ser. No. 60/465,437, filed Apr. 25, 2003, entitled Self-Calibrating Video Display Apparatus and claims the benefit of the filing date thereof for all common subject matter.

### FIELD OF THE INVENTION

This invention relates to an LED illumination source/display particularly suitable for large format video and graphic displays in the form of signs and billboards suitable for viewing by a large number of individuals.

### BACKGROUND OF THE INVENTION

Prior Art Video Displays

Large signs and billboards have been in wide use for many years as a medium for advertising and for imparting information to the public. Traditionally, signs and billboards have been used to exhibit a single advertising theme, product, or message. Due to the fixed print nature of this medium, it does not lend itself to displaying a larger series of ideas as would be common with a medium such as television. Phosphor and incandescent emissive based display technologies have to a limited extent achieved success in displaying varying images in large outdoor and indoor displays. However, advances of technology in illumination sources such as light emitting diodes (LEDs) have allowed such diodes to largely replace phosphor and incandescent displays for large format outdoor and indoor displays, e.g., having a diagonal dimension in excess of 100 inches, which are to be viewed from distances of 20 or more feet in ambient lighting conditions requiring display brightness of say over 500 nit. The term LED is used herein to collectively refer to the light generating semiconductor element, i.e., LED DIE as well as the element packaged with a lens and/or reflector.

The current economics and price/performance of traditional LED video and graphic displays is sufficient to replace incandescent, CRT and protection display technology in the existing high value markets, however, the traditional LED displays themselves have drawbacks that impair the growth potential of such displays.

LED video/graphic boards, as they are common called, utilize color LEDs arranged in pixels (as discrete groups) forming an array. Each pixel, which comprises a group of LEDs, e.g., red (R), blue (B), and green (G), is capable of emitting light of a desired color or hue representing the smallest increment (or perceived point) of the displayed image.

LED Displays and the Degradation Problem

The benefits of brightness, life and power saving of LEDs, used as illumination sources, come with a random distribution of brightness, dominant wavelength (color coordinate), and LED chip (DIE) structure with its inherent degradation during use at the pixel level. The degradation rates and profiles are different for individual LEDs or packaged LEDs within a production run or lot. Sorting the individual LEDs into smaller distributions of brightness and hue-bounded ranges, reduces the negative effect on initial quality only. The long term effect of LED degradation results from LED accumulated operational time and is accelerated by increases in operating junction current, temperature and humidity. The degradation profile also varies by the uniformity of the LED junction resulting in the intuitive and empirical deduction that brighter LEDs (or packaged LEDs) and therefore LEDs from a particular wafer lot are also structurally better LEDs with lower degradation rates than the lower brightness LEDs from the same lot.

The operating time of video display and advertising systems used for sporting events averages less than 800 hours per year. Such a system would rarely be in operation over 1,500 hours a year even in a common area accommodating two sporting events such as basketball and hockey. In such use the accumulated individual pixel energization or per primary color LED(s) in a dual use would be less than 400 hours for blue and near 800 for red and somewhat less for green.

Out of home advertising (“OHA”) is generally calculated to place about an 8,760 hour per year burden on the display system. In addition, such advertising is dominated by static image content that results in an increased operational time over the video intensive content of sporting events. High ambient light OHA locations may result in content and LED lamp operational time estimated to be well over 20,000 hours in a five year period. Other variables, such as border vs. center module distribution, dominant color of image and background may exacerbate a pixel or group of pixel's operational time and thereby the degradation of the LEDs constituting a pixel or group of pixels.

OHA is dominated by still images where the quality benchmark is print media and image quality is often critical. According to Mr. Charles Poynton, a recognized authority on color in electronic displays, a color difference >1% is discernable to an average observer. Advertising content for food, clothing, cosmetics and automobiles often contain fine shading and gradual color gradients. Accurate color rendering is essential to image quality and ultimately advertiser satisfaction and consumer acceptance of an accurate rendering of the actual merchandise.

In our prior U.S. Pat. No. 6,657,605 (“'605 patent”), the LED modules making up the display are characterized at the pixel level to make uniformity correction possible. Uniformity correction, in turn, provides a uniform brightness of each primary color LED within the entire display.

Uniformity correction with external light sensors is discussed generally in the '605 patent and is recapped below:

LED lamps from Nichia or other vendors such as Agilent, Lite-On, Kingbright, Toyoda Gosei and others, are sorted into groups called ranks or bins having an intensity variance of candlepower (cd.) ±15% to ±20%. The implementation of uniformity correction begins with the assumption that like ranks of LED lamps having a ±10% variance may be procured from the above suppliers at a modest premium. Volume production of the video display apparatus referred to as LED modules then takes place with specific ranks used in specific LED modules. In LED modules so constructed, the LEDs of one rank are operated at one forward current level I_{fr}, determined by their rank and LEDs in other LED modules of lower rank are operated at a higher level, such that all LED modules used in a particular display during a production lot, have a similar non-uniformity corrected average brightness that approximates D6500 white (i.e., simulation of the radiation from a black body at 6500° k) when operated at the same R, G, B level.

In accordance with this preferred method, the power supply and constant current source drive electronics for energizing the LEDs varies the LED(s) output intensity by modulating a fraction or percentage of the time the LED(s) is turned on within an image frame interval. Such modulation is commonly referred to as pulse width modulation (PWM). The term % ON TIME as used herein denotes that percentage value which may vary between 0 and 100, where 0 represents the LED is fully off and 100 represents that the LED is fully on.

Next a characterization or test system measures the brightness of each LED color in each pixel of the module when operated at a fixed level(s) of input energy to a high level of repeatability (<±2%). The normalized brightness of R, G, and B color required for SMPTE D6500 white for the whole display configured of specific LED modules is then calculated and a table of uniformity correction coefficients generated. The system applies the uniformity correction coefficient data to the image data which causes each pixel to perform as if it were part of a matrix of LED pixels having uniform intensity.

Prior Art Approaches to the Degradation Problem

The LED display, so comprised, will appear to have an image quality noticeably superior to those that do not employ some form of uniformity correction. While this solution provides for exceptional image quality of a new display, the long-term prognosis leaves much to be desired outside the intermittent operation during sporting events. As an LED display ages the maintenance cost escalates and average color uniformity degrades in a somewhat predictive manner determined by LED accumulated operational time. Some LED video display manufacturers use a predictive algorithm to compensate for LED degradation within the display. Non-predictive factors such as environmental stress in packaging and individual DIE characteristics cannot be accounted for based on content derived predictive models. This deficiency may be overcome by measuring the brightness, i.e., luminous intensity, of each color LED(s) within each pixel and compensating for the degradation by supplying additional energy or % ON-TIME in response to the signal image data for that pixel such that it produces the same optical output as it did when the pixel's output was first characterized.

The industry standard LED display module construction employs an array of “Super-oval” 50 deg×110 deg, LED lamps soldered to a printed circuit board which is then affixed to and potted within a mounting frame where the potting material sealing the LED lamps is black opaque to provide contrast to the emitted image light. A typical 13′4″×48′ electronic bulletin billboard will have 92,160 pixels spaced 1″ apart and 368,640 LEDs contained within its 360, 16 pixel×16 pixel, LED modules.

Once the display is placed in the field the only practical way to counteract LED degradation is to use an external measurement device such as an externally positioned calibrated CCD camera to measure the value of the light output of each LED within each pixel. This value can then be compared to the value at the time of characterization and the energization of each LED can then be adjusted to achieve a uniform response to a known generated pattern. While this method may be suitable for displays concentrated in locations such as Las Vegas, Times Square, and the Los Angeles Sunset Strip, it is not feasible to maintain the calibration of the image quality of thousands of electronic billboards that would be fielded by the billboard operators in the United States.

There is clearly a need for an LED illumination source such as an LED billboard module design that is able to maintain the display's image quality without the use of an external measurement device. In particular, there is a need for a feedback based light sensor that is internal to the illumination source/display which can provide a measure of the light emitted, e.g., luminous intensity representative of a discrete color, from each LED(s) within each pixel. The term pixel as used herein means a group of LEDs which represent a finite area of the source or the smallest increment or perceived point on a display and capable of replicating all of the colors and hues of the source/display.

With respect to the use of light sensors with LEDs it is not new to package such a sensor/detector together with an LED. For example, opto-isolator or opto-couplers have been widely used for the purpose of transmitting data across an electrically isolating barrier through an optically transmissive medium such as a light pipe. Photodiodes are also used to provide feedback as an integral part of a laser diode package for output control.

Also see U.S. Pat. No. 5,926,411 issued to James T. Russell which describes a CCD detector and circuit to set the threshold for data detection and even the possibility of using the LED as a detector. Notwithstanding the existence of LED sign and billboard display systems and the specialized prior art use of photodetectors the need discussed above has remained unfulfilled.

### OBJECTS OF THE INVENTION

An objective of the present invention is to provide a means for an LED display to detect and compensate for expected degradation of the LEDs' light output over the life of the display. It is a further object to provide an integral photodetector in close proximity with one or more LEDs to enable the light output from each LED(s) at any time during its life to be measured. It is another object to produce and maintain a quality image on an LED display composed of a multitude of pixels by controlling the absolute output luminance of every LED representative of each discrete color in each pixel so that the display appears uniform in brightness and color across the entire display.

The term “LED(s)” as used herein means the single or multiple LEDs in each pixel which are responsible for emitting light of a discrete color. For example, two red LEDs are illustrated in FIG. 4 for emitting light perceived as red.

### SUMMARY OF THE INVENTION

An LED area illumination source or display, such as an electronic billboard display, is made up of a plurality of individual pixels of LEDs with each pixel comprising a plurality of LEDs, e.g., red, green and blue packaged singly or together, with the LED(s) representing a discrete color being arranged to be separately energized so that by simultaneously energizing one or more of the LEDs any desired color can be emitted from the pixel. At least one light sensor is arranged to provide an output signal representative of a measure, e.g., the luminous intensity of emitted light from each of the LED(s) of the source/display when said LED(s) is separately energized. At least one light sensor may comprise a sensor associated with one or more pixels or with each LED.

In accordance with a method of determining the LED degradation in the source/display, each LED(s) representing a discrete color in each pixel is separately energized at a given level which may, but need not be, the same for all LEDs, e.g., 100% ON TIME, at a time to of characterization. At the same time the output signal of the associated light sensor is read and stored with the output signal bearing a given relationship with the emitted light, e.g., luminous intensity and the level of energization. At a time tₙ subsequent to tₒ each LED(s) representing a discrete color of each pixel is separately energized at a given level, e.g., 100% ON TIME and the output signal of the associated sensor is read and compared with a value of the corresponding output signal at tₒ.

Assuming that the display, at the time of characterization is operated at less than the maximum energy level for all LEDs, e.g., less than 100% ON TIME, the individual LEDs may be restored to their characterization status, by using the difference between the tₒ and tₙ sensor output signals to control, i.e., increase, the energization, e.g., % ON TIME of each LED(s) which has suffered degradation.

The construction and operation of the present invention may best be understood by reference to the following description taken in conjunction with the appended drawings.

### BRIEF DESCRIPTION OF THE DRAWINGS

FIG. 1 is a front view of a video display module comprised of an array of pixels with each pixel including a plurality of LEDs;

FIG. 2 is a block diagram of an electronic system for supplying energy to the LEDs in the array of FIG. 1 and reading the outputs of the embedded photodetectors;

FIG. 3 is a front view of one of the pixels of FIG. 1;

FIG. 4 is a cross-sectional view taken along line 4-4 of FIG. 3;

FIGS. 5, 6, and 7 are perspective, top plan (with the lens omitted), and cross-sectional views, respectively, of an alternative pixel arrangement in which Led active elements, i.e., LED DIEs are packaged together with the active element of a photodiode in a single envelope;

FIG. 6a is a blown-up plan view of the LED/photodiode active element of FIG. 6;

FIGS. 8, 9 and 10 are perspective, top plan, and cross-sectional side views, respectively, of a modified embodiment of the pixel of FIGS. 5-7;

FIG. 11 is a cross-sectional view of a pixel being calibrated or characterized by a spectraradiometer;

FIG. 12 is a block diagram of a test system for characterizing the display module;

FIG. 13 is a diagrammatic view of a section of the photodetector array of FIG. 2 along with a measurement circuit for reading the detector outputs;

FIG. 14 is a flow chart of an algorithm for self-calibrating a single LED;

FIG. 15 is a more detailed flow chart of the characterization algorithm and correlation of the photodetector outputs to the LED light output and energization level;

FIG. 16 is a flow chart illustrating optional operations of the display;

FIG. 17 is a flow chart showing the self-calibration process; and

FIGS. 18-21 are flow charts illustrating optional display modes.

### DESCRIPTION OF THE PREFERRED EMBODIMENT

Use of an Internal Photodetector to Measure the Emitted and Ambient Light An LED illumination source or display made up of an array of modules with each module comprising individual LED groups or pixels, with each pixel constituting a finite area or smallest increment of the source or display, is described in our co-pending U.S. application Ser. No. 10/705,515 (“'515 application”), filed Nov. 16, 2003, entitled Video Display Apparatus and the '605 patent. The contents of the '515 application and the '605 patent are incorporated herein by reference.

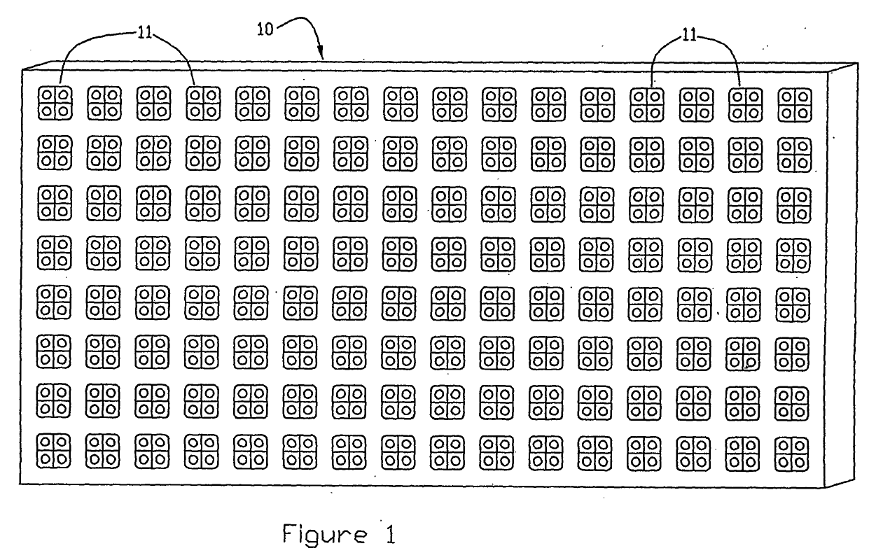

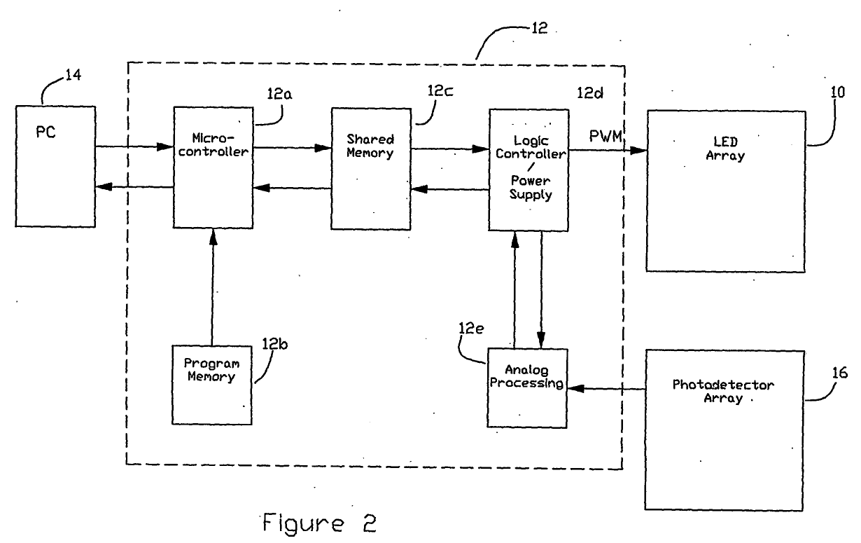

Referring now to the figures, FIG. 1 illustrates the LED video display module or array 10 as described in the '605 patent in which the array is comprised of individual pixels (picture elements) 11. It is to be understood that a video display is conveniently constructed of individual modules which are assembled in an array to make up the completed sign or billboard. The term “array” as used herein shall mean an individual module or array. A system for operating the array 10, while providing self-calibration, is illustrated in FIG. 2 in which PWM current is supplied to the LED array via an electronic module 12 incorporated into the array with the module 12, including a microcontroller 12a, a program memory 12b, a shared memory 12c, a logic controller/power supply 12d and an analog processing circuitry 12e. A PC 14 controls the operation of the electronic module. A photodetector array 16, embedded in the array, supplies the output signals from the individual light sensors or photodetectors associated with each pixel or LED to the electronic module 12 as will be explained.

The implementation of the illumination source/display 10 of the '515 application, to incorporate an internal light sensor/photodetector for measuring the emitted light from each LED(s) representing a discrete or primary color and the electronics to operate the same, is the subject of this application. Only a single LED group or pixel will be described in conjunction with FIGS. 4-10 with the understanding that many such pixels will be grouped to form an array. In addition, while the '515 application specifically provides for the use of a diffractive optical element to disperse the emitted light in an elliptical pattern, the present invention is not limited to the use of such a diffuser. Also, as will be discussed in more detail, one or more LED DIEs along with a light sensor can be mounted within a single optical package, e.g., sharing a single reflector/lens.

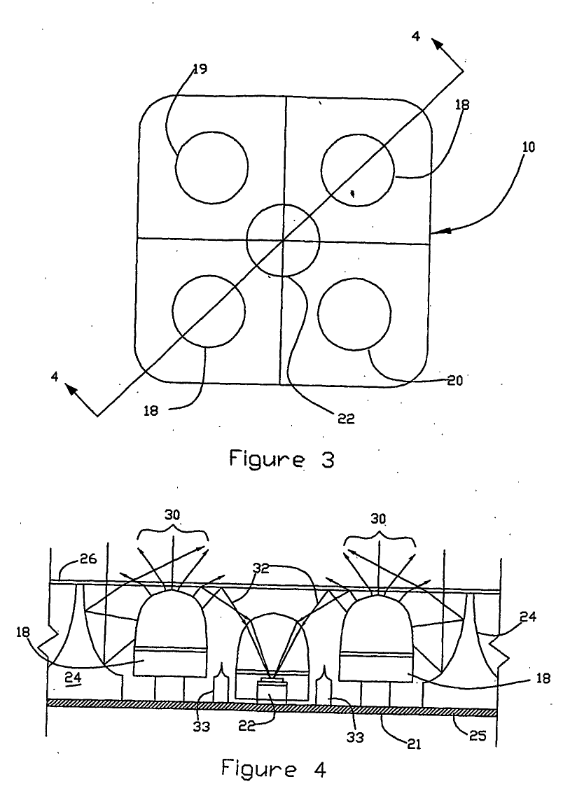

FIGS. 3 and 4 illustrate a single pixel including two red LEDs 18, one blue LED 19, and one green LED 20. It is to be noted that the number of LEDs and the distribution of color within each pixel is not restricted to those just mentioned. To create various color temperatures additional LEDs with differing emitted wavelengths may be incorporated into a pixel. The LEDs are mounted on a printed circuit board 21 via a conventional surface or through hole mounting arrangement. A light sensor or photodetector 22 in the form, for example, of a PIN or PN photodiode is also mounted on the circuit board adjacent to the LEDs, such as in a center position, as shown in FIG. 3, to receive light emitted from each of the LEDs. A housing 24 supports the circuit board and a light shaping diffuser 26, such as that described in the '515 application, is adhesively bonded to the housing. Light, designated at 30, is radiated out of the pixel. Some of the light 32, emitted by each LED, is reflected internally, for example, by the diffuser 26 and reflectors 33 secured to the circuit board, such that a small, but fixed percentage of radiated pixel light is received by the photodiode 22 contained within the pixel.

In an alternative embodiment to that shown in FIGS. 3 and 4 the pixel may be formed of a chip set 34 in which a plurality of LED DIEs and a light sensor/photodiode junction are mounted on a common substrate as is illustrated in FIGS. 6 and 7. The chip set includes two red LED DIEs 36, one blue LED DIE 38, one green LED DIE 40 and a photodiode junction 42. The term light sensor/photodiode as used herein shall collectively refer to a photodiode packaged in a separate envelope as is illustrated in FIGS. 3 and 4 or to the junction packaged in an envelope containing one or more LED DIEs.

A one piece molded lens/reflector 44b is mounted to the circuit board 21 over the chip set 34. The lens/reflector is' shown as including support posts 44a secured to the underlying circuit board.

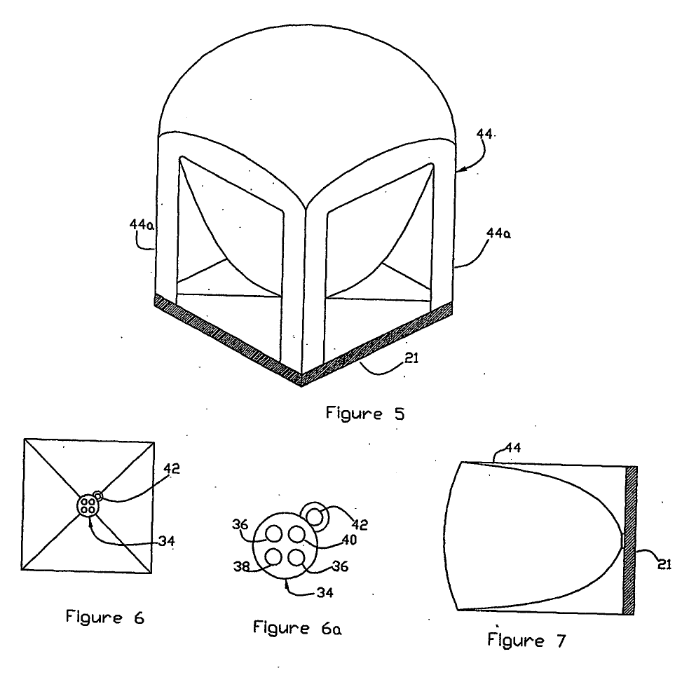

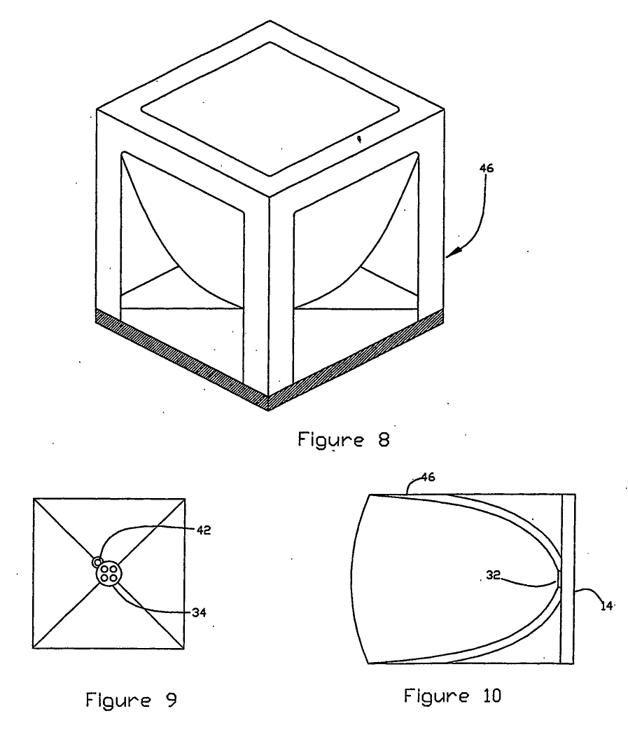

FIGS. 8-10 illustrate a further embodiment to that shown in FIGS. 5-7 in which the chip set 34 is positioned within a reflector 46 which directs the light emitted from the LEDs outwardly in a somewhat collimated beam. In either of the above embodiments, like the system of FIGS. 3 and 4, a portion of the LED emitted light is received by the associated photodiode.

All the optical elements 18-20 and 22 of FIGS. 3 and 4 or elements 36, 38,40 and 42 of FIGS. 5-10 are fixed relative to each other as well as to the diffuser 26 and the reflector 33 if used. The amount of radiation impinging on the photodiode from any LED or combination of LEDs, representing a discrete color, e.g., red, within the pixel is in direct linear proportion to the radiation emitted by that LED or combination of LEDs within the pixel. This assumes any ambient light effect is eliminated or known and cancelled and that while the responsivity of the photodiode may vary for the red, blue and green LED spectral emission, the response with respect to any LED(s) remains constant over time and operating temperature. This arrangement of LEDs and internal photodiodes in an area illumination source or video display allows for (1) compensation of individual LED degradation (i.e., self calibration); (2) detection of LED catastrophic failure; (3) confirmation of the display image (i.e., content validation); (4) continuous display brightness (i.e., automatic brightness control) by measurement of ambient light level; (5) brightness compensation for a partially shadowed display and (6) detection of a light output obstruction (e.g., graffiti) as will be explained in more detail.

Overview of the Characterization of the Array and Preparation for Subsequent Self-calibration

In order to display a quality image the brightness, i.e., luminance, i.e., luminous intensity, and color, i.e., chromaticity, of each pixel must be controlled by modulating the intensity of the individual LEDs in proportion to one another such that their combined light outputs produce the desired intensity and color. As pointed out earlier, in the preferred embodiment the display electronics of FIG. 2 varies an LED's light output intensity by modulating the fraction of time the LED is turned on within an image frame interval, i.e. PWM. This allows varying the LEDs perceived output intensity, i.e., luminance, without changing its perceived color.

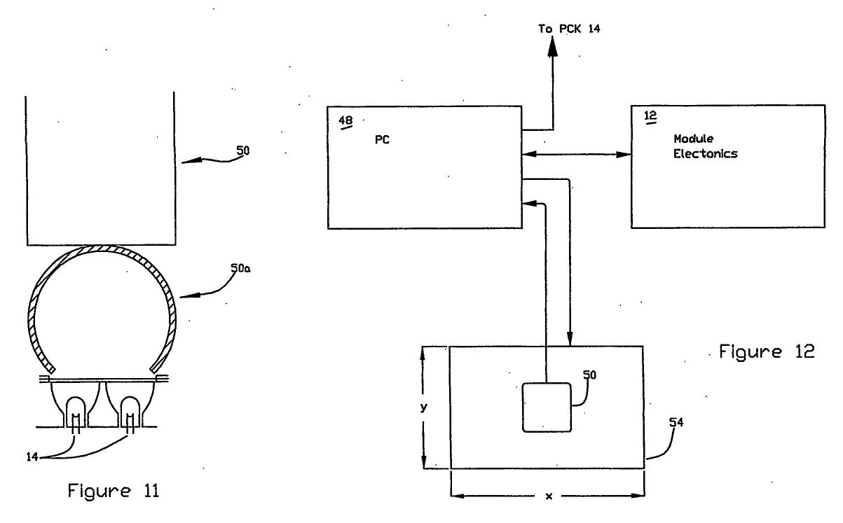

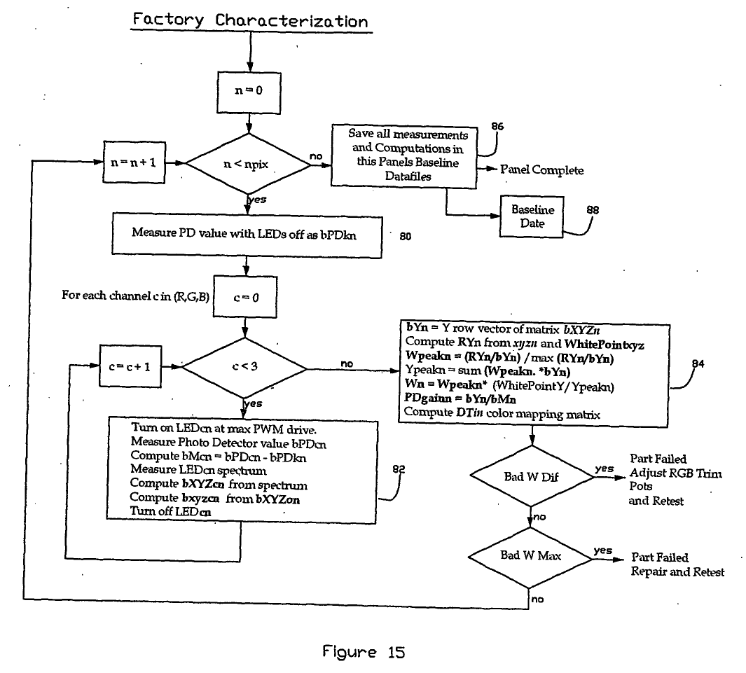

In an overview of factory calibration, i.e., characterization, and subsequent self-calibration, a test system shown in FIGS. 11 and 12 sequentially drives each LED (illustrated as red LEDs in FIG. 11) at full output intensity, i.e., 100% ON TIME. The test system includes a PC 48 which controls an x-y table 54 on which the array is mounted during characterization so that each pixel is sequentially positioned under a calibrated spectraradiometer 50 with its light integrating sphere 50a (discussed in the '605 patent). The spectraradiometer 50 measures the luminous intensity and spectral characteristics of each LED representative of a discrete color in each pixel. The test system computes a tri-stimulus value chromaticity vector bxyn, for each Led(s) representative of a discrete color corresponding to the CE (Commission Internationale de l'clairage) 2 deg xyz chromaticity coordinates for each primary color as will be explained in more detail in connection with FIG. 15. The measurement is stored in a file which is then transferred to and stored by the PC 14 of FIG. 2 for operational use.

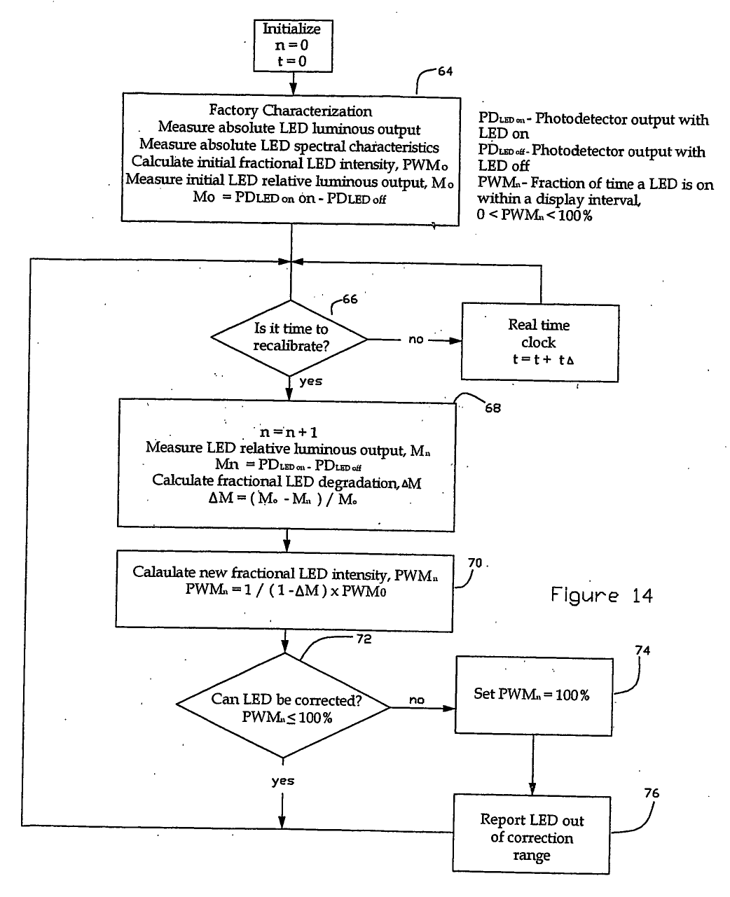

The outputs of the embedded photodiodes 22 associated with each LED(s) representative of a discrete color of each pixel are also measured with the LED on and with the LED off. Preferably the on measurement is made with the LED ON TIME set at 100%, as pointed our earlier. The measured photodiode outputs are sometimes referred to herein as output signals. The off measurement, corresponding to the ambient light level, is subtracted from the on measurement corresponding to a portion of the LED light output plus the ambient light level yielding a baseline photodetector measurement (Mₒ, FIG. 14) for each LED(s) representing a discrete color for each pixel. This measurement is stored in memory 12b for operational use. A factor representative of the characteristic response, (e.g., gain in terms of lumens/volts) of each photodiode to the luminous intensity of the light from each associated LED(s) representing a discrete color within that pixel is also calculated and stored in memory 12d at the time of characterization.

A factory calibration algorithm computes an initial, unique % ON TIME for each LED(s) representing a discrete color for each pixel based on the following criteria. The luminous intensities for red, green, and blue LEDs are adjusted to be in proportion to one another such that the required white point, e.g., D6500 is achieved across the entire display when the display is commanded to display white. Further, the target White Point luminance output value is adjusted to be the same for each pixel so that uniform brightness is achieved across the entire display when all pixels are commanded to display the same color and intensity. Finally, it is noted that the selection of suitable LEDs with sufficient light output assures that at factory calibration sufficient intensity margin, i.e., head room, is provided for such that as an LED degrades in output intensity over time, its optical output intensity can be increased to its initial value by increasing the PWM(n) % ON TIME thereby maintaining uniform intensity and color balance across the entire display.

The final values of the energization level, i.e., % ON TIME for each LED(s) representing a discrete color in each pixel (or group) is stored at the time of characterization, i.e., tₒ.

There are several circuits that may be utilized to read the output signals from photodiodes during characterization as well as subsequent calibration. One such circuit incorporates a light-to-frequency converter and a photodiode into a single package or component such as those manufactured by Taos, Inc. of Dallas, Tex. The light-to-frequency converter is a single integrated circuit with a photodiode sense array analog detection circuit and a digital output whose frequency is proportional to the LED luminous intensity output from the component.

The light-to-frequency converter component provides linearity over a broad range of light input signal and interfaces directly with digital microprocessors and programmable logic arrays. The downside to the use of such a anticipated component is cost in view of the number of devices required for a large array of pixels.

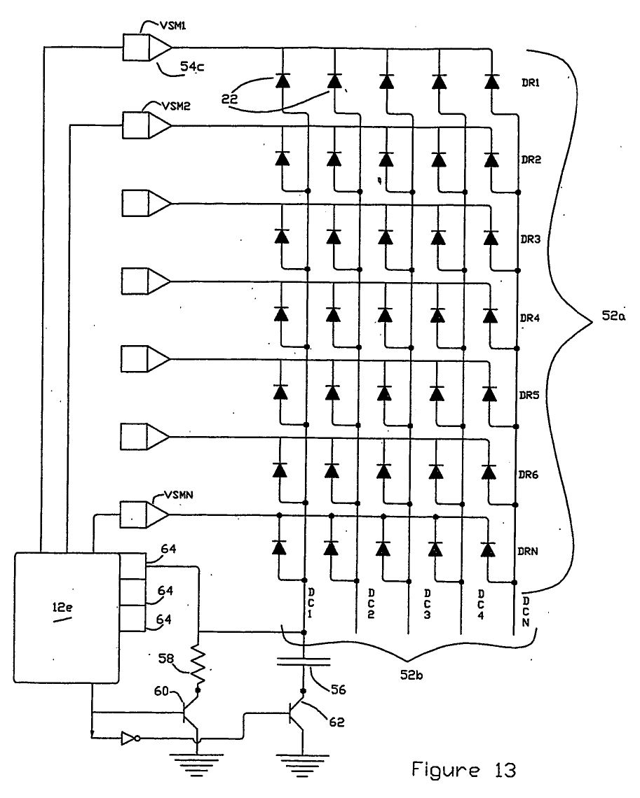

Another technique for measuring the light impinging on the photodiodes is commonly used in digital cameras. A circuit following this technique is shown in FIG. 13. The circuit connects the photodiodes 22 in a conventional matrix along rows 52a (illustrated as DR1-DRN and columns 52b (illustrated as DC1-DCN). For sake of simplicity, voltage (electron) sources labeled VSM1-VSMN, are connected to the cathodes of the rows of diodes as shown. The election sources, while shown separately, form part of a power electronics module 12 incorporated in the LED display array.

A capacitor 56 is discharged through a discharge resistor 58 by a switching transistor 60. The red, green or blue LED source in the pixel (row 1, column 1) to be characterized or calibrated is driven at a desired operating current level, e.g., 100% ON TIME via PWM electronic module 12. After the rise time of the drive circuit current has expired the drive current referred to as forward current will be stable, causing photons of the specific color to be radiated in proportion to the forward current for that specific LED(s) of the individual pixel.

The electron source VSM1, via the module 12, supplies electrons to the photodiode row. At the same time transistor 60 is turned off removing the charge drain on capacitor 56 and transistor 62 is turned on allowing the measurement capacitor 56 for column 1 to begin to accumulate a charge through a photodiode 22. The rate of charge is in direct proportion to the number of photons absorbed by the photodiode semiconductor element.

The electronics module 12, under the control of PC 14, measures time interval Tm between the column measurement capacitor 56 transitioning from 10% to 90% of the source voltage VSM1. Since the photodiode semiconductor element exchanges one electron for one photon absorbed, the portion of light absorbed by the photodiode from the LED source is thereby measured and supplied via an A/D converter labeled as 64 (incorporated into 12e) to the electronics module 12 for storage.

Any decrease in light output from the LED source of a particular pixel will result in a decrease in light measured by the PN or PIN-photodiode semiconductor element and its associated circuit within that particular pixel in direct proportion to the amount of decrease.

Since the objective of the measurement is to determine the amount of LED output degradation it is only necessary to determine the percentage of decrease in output relative to the known output for the pixel at the time the characterization was made. Alternatively, the amount of increased input energy to the pixel LED required to bring the pixel output to the original level at characterization may be determined. It is therefore required that the measurement be accurate in the proportion of electrons exchanged for a light level with the pixel.

A new uniformity correction factor may then be calculated for red, green and blue LED output for each pixel that increases the amount of % ON TIME required to raise the pixel output for each color to the level when that pixel was initially characterized.

The amount of additional energy output required in the form of an increased % ON TIME needed to compensate for the LED degradation is calculated in the LED module's microprocessor and added to that required to generate a specific % ON TIME energy output for the image as determined by the display system logic producing uniformity corrected data delivered to the display modules.

Overview of Self-calibration

The flow chart of a simplified self-calibration algorithm is shown in FIG. 14. At time tₒ the display is characterized as shown in step 64. At a later time 66 the module determines if it is time to re-calibrate and if the answer is yes the steps shown in 68 take place resulting in a calculation of a fractional LED degradation AM for each LED(s) representative of a discrete color. Step 70 illustrates the calculation of a new pulse width modulation fraction or % ON TIME. In step 72 the system determines whether the LED can be corrected to provide its original emitted light intensity. If not, the pulse width modulation level is set at the highest level, i.e., 100% and the LED is reported to be out of correction range by a signal stored in the electronics module and sent to a remote site. As will be noted in the next section, the PWM of the remaining LEDs in that pixel (or the array as a whole) can be decreased to return this pixel to its original chromaticity. In step 72 it is also determined if the LED can be corrected and, if so, the system selects another LED for determining its degradation, if any, and the process is continued until all of the LED(s) representative of a discrete color in each pixel have been processed through the self-calibration procedure. It should be noted that this procedure can be conducted simultaneously on many pixels providing that emitted light from neighboring pixels does not interfere with the accuracy of the readings.

Characterization Self-calibration and Normal Operation Algorithm

Referring now to FIG. 15 the baseline photodector measurement bMCn is measured in steps 80 and 82 and the tri-stimulus chromaticity vector bxyzcn is computed as discussed earlier.

Following the measurement of the 3 primaries associated with each pixel (Red, Green, Blue), the test system performs computations (84) that yields three characterization parameters, Wn, PDgainn, and DTin, that are computed from the desired intensity of the pixel, the desired white point of the pixel, and the measured chromaticity and intensity of the pixel (82). Wn is a vector of 3 PWM scaling factors that produce a target white point for pixel n. The output luminance value is selected at a value lower than the maximum possible so that there is ample headroom in the PWM drive to the LEDs so that the drive levels can be increased later in the display's life to compensate for a reduction in luminance as the LEDs age. PDgainn is a vector of 3 calibration gain factors for the 3 LEDs in the n^{th} pixel that relate the absolute LED output measured by the spectra-radiometer to the relative LED output measured by the integral photodetector. DTin is a 3×3 color mapping matrix which is computed from the spectra-radiometer measurements, bXYZn, and corresponds to the color characteristics of the display's pixels (82).

When the test system completes the characterization of an LED panel (86), it saves all the measurements and computations in a data file (88) for later use by the display in normal operation.

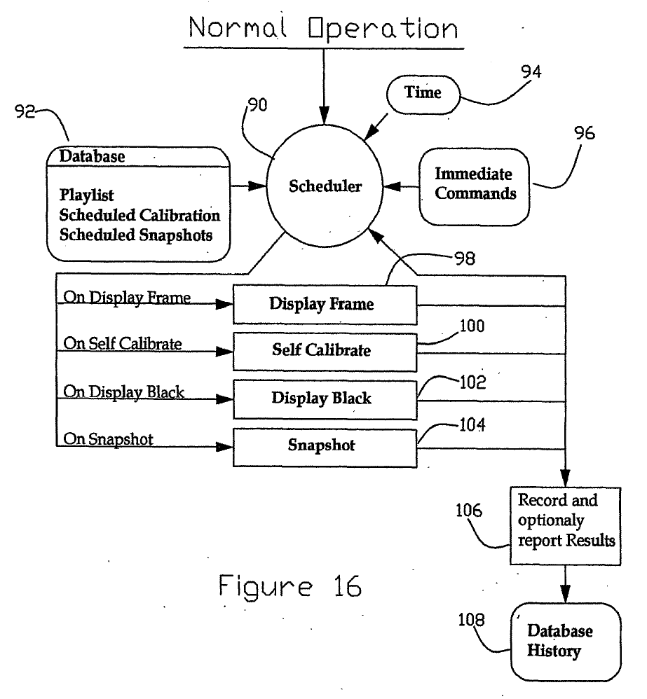

Referring now to FIG. 16, following factory characterization of LED display modules, assembly, test and display deployment, the LED display begins normal display operation. A scheduler (90) performs four different display operations that are automatically determined by entries in the display's internal database (92) in conjunction with the time of day (94) or by immediate commands (96) that can be delivered to the scheduler on demand by remote operator interaction. The display operations are Display Frame (98), Self Calibration (100), Display Black (102) and Snapshot (104) to be elaborated further. Results of each of the operations are recorded (106) to a history database (108).

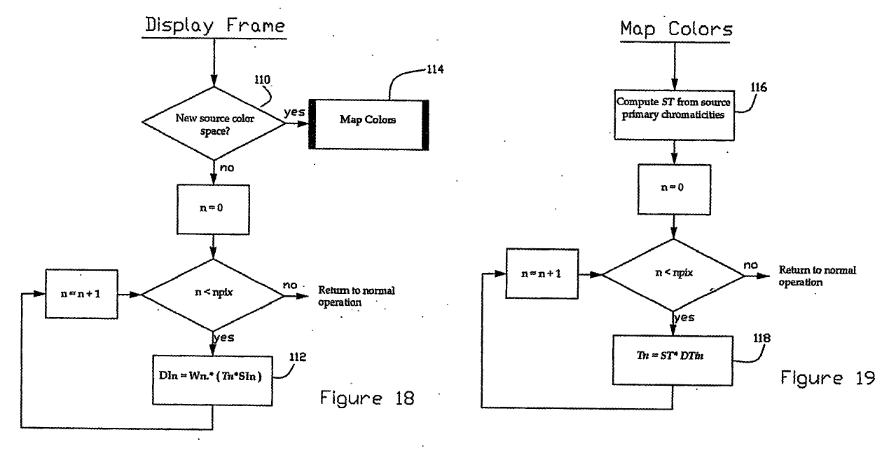

The normal operating mode of the display is Display Frame which displays the desired scheduled images for viewing by the targeted viewers. The source image data has an associated color space that defines how the source image RGB components are to be interpreted. If the source color space has not changed since the last display frame operation (110, FIG. 18), the display processor computes each pixel vector, DIn, for all pixels in the display (112), displays the frame and returns to the scheduler (90). If the source color space has changed (110), the display processor performs the Map Colors operation (114). The DIn vector contains the three LED PWM values required to drive the LEDs in the n^{th} pixel according to the source image value. SIn is the source image vector (Red, Green, and Blue components) for the n^{th} pixel in the source color space. It is multiplied by a 3×3 color space transform matrix, Tn, The result is further multiplied by the Wn scaling matrix which derives initially from factory characterization (84), and later from Self Calibration (100) after a self calibration operation is performed. The display processor returns to the Scheduler (90) when all pixels in the display have been processed.

The Map Colors (114) operation computes the source transform matrix, ST, from the source primary chromaticities (116, FIG. 19) so that the color space of the source image data may be accounted for. The transform matrix, Tn (118), for each pixel is computed as the matrix product of the source transform matrix, ST, and destination transform matrix, DTin. The transform matrix combines the source color space parameters with the destination color space parameters to yield a color space correction matrix that transforms a source image vector (RGB) to a destination image vector (RGB) for display in the Display Frame operation (112).

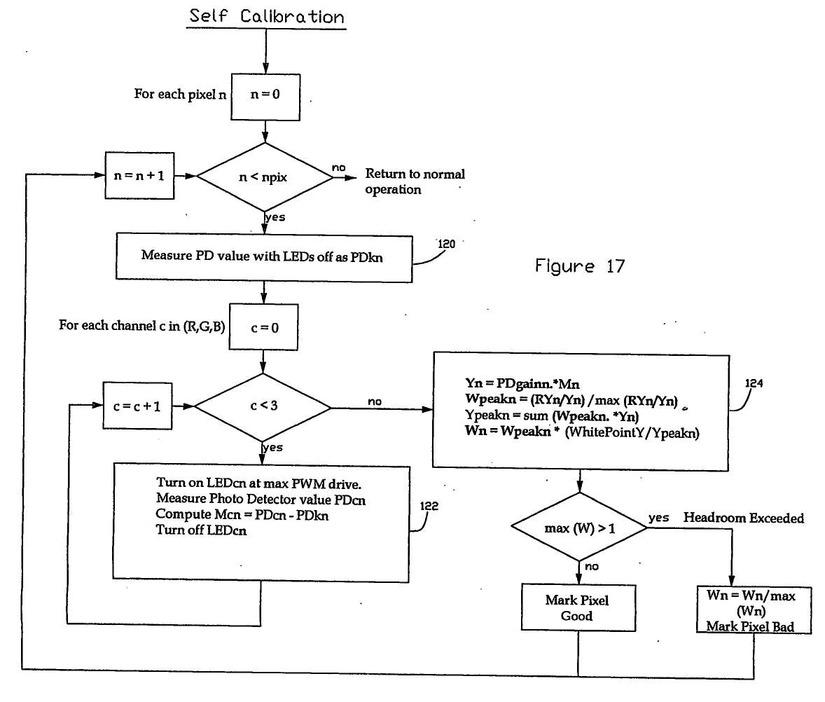

The next Scheduler (90) operation is Self Calibration (100). The Self Calibration operation is scheduled periodically for the purpose of checking the condition of the LEDs and adjusting the output luminance of LEDs that have degraded over time. This operation is similar to Factory Characterization, but does not use a spectraradiometer to characterize the LEDs. Instead, only the integral photodetector measurements are utilized to infer the actual LED output luminance. The Self Calibration operation first measures the outputs of the integral photodetectors associated with each LED with the LEDs off (120). See FIG. 17. The system then drives each LED at full output intensity, measures the photodetector value, and subtracts out the ambient light level measurement(LEDs off) to yield a photodector measurement, MCn (122), for each LED. After each LED of a pixel is measured, the PDgainn factors and RYn factors that were computed in Factory Characterization (84) are applied to the photodetector measurements to yield a new Wn vector (124). When the display resumes its Display Frame (98) operation, the display processor utilizes the new Wn vector to scale the input (112) such that the output luminance of each pixel is maintained. The display processor returns to the Scheduler (90) when all pixels in the display have been processed.

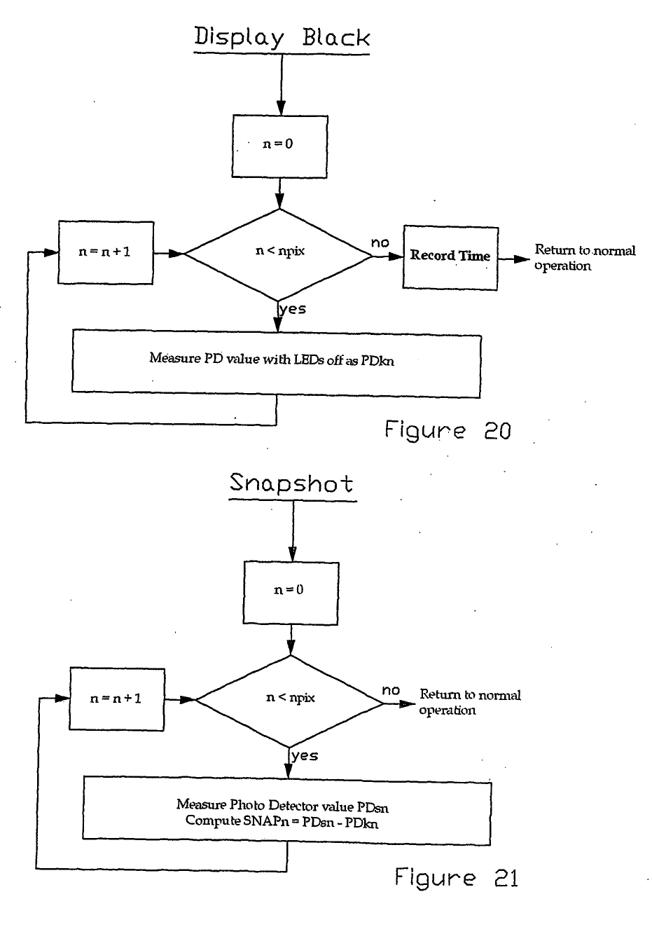

The next Scheduler (90) operation is Display Black (102). Display Black measures the integral photodectors with all the LEDs turned off (126) during the black time between displaying images. See FIG. 20. These measurements record the ambient light present. They are time-stamped (128) and saved for use in the Snapshot operation (104). The display processor returns to the Scheduler (90) when all pixels in the display have been processed.

The Snapshot operation (104) measures the integral photodetector values (130) while the display is showing a static image. See FIG. 21. The SNAPn value for each pixel is the sum of the light being emitted by all three LEDs of a pixel and represents the gray-scale luminance of that pixel. When all SNAPn values are displayed on a monitor screen, the image will appear as a gray-scale representation of the color image. This information can be used to verify that the intended image to be displayed was actually displayed by either human visual interpretation or by computationally comparing the SNAP image to a gray-scale version of the displayed image. The display processor returns to the Scheduler (90) when all pixels in the display have been processed.

Glossary of Terms Used in Flow Charts, FIGS. 15-21

Features:

Uniformity Correction

Full Uniformity Correction is achieved as all pixels are adjusted by their W factors to the same target white point and luminance.

Color Correction

Each pixel has its own color transform T for precise color mapping.

This matrix is recomputed each time the source color information changes.

Without this, even though a pixel PWM driven at W will produce the target white point and luminance, any differences between the primaries will cause other RGB drive ratios to produce different colors.

The color transform matrix corrects for this.

Constants

npix=Scalar: Number of pixels in the panel

Headroom=Scalar: % PWM scale to reserve for compensation

MaxWDif=Scalar: (max dif between W components)

Other

n Scalar: pixel number (0 . . . npix−1)

c=Scalar: channel number (0=r=Red,1=g=Green,2=b=Blue)

PIXn=name: Pixel n

LEDc=name: LED channel c

Scalar Vector Matrix Operations

S′=max(V)=Scalar: Max of vector elements

S′=sum(V)=Scalar: Sum of vector elements

M′=M*M=Matrix: Matrix Matrix Multiplication

V′=M*V=Vector: Vector Matrix Multiplication

V′=V−V=Vector: Element by Element subtraction

V′=V.*V=Vector: Element by Element products

V′=V*S=Vector: Products of Each Element and S

V′=V/S=Vector: Quotient of Each Element and S

Target White Point Information

WhitePointY=Scalar: Target White Point Luminance

WhitePointxyz=Vector: Target White Point Chromaticity

WhitePointy=Scalar: y component of WhitePointxyz

Baseline Data

bPDkn=Scalar: Baseline Photo Detector Reading for blacK (All LEDs OFF) for pixel n

bPDn=Vector: Baseline Photo Detector Readings for R,G and B for pixel n

bXYZn=Matrix: CIE 1931 2 deg XYZ tristimulus values for each primary for pixel n
: Each column col contains X,Y and Z for 1 primary for pixel n
: cols 0=r,1=g,2=b
   Baseline Calculations

bPDcn=Scalar Element c of bPD for pixel n

bMn=Vector Baseline Photo Detector Measurments for R,G and B for pixel n
:=bPDn−bPDkn

bMcn=Scalar: Element c of bMn

bYn=Vector Row Y of bXYZ for pixel n

PDGainn=Vector: Gain factors to convert from M to Y for R,G and B for pixel n
:=bYn/bMn

bxyzn=Matrix:CIE 1931 2 deg xyz chromaticity coordinates for each primary for pixel n
:Each col is bXYZc/sum(bXYZc)

byn=Vector: y row vector of bxyz for pixel n

bxyzin=Matrix: Inverse of bxyzn

Jn=Vector: Intermediate value in color calculation for pixel n
:=bxyzin*transpose(WhitePointxyz/WhitePointy)

RYn=Vector: Relative Y contributions for chanels to produce target white point
: chromaticity for pixel n
:=by.*transpose(J)

MJn=Matrix: Diagonal Matrix of Vector Jn

DTn=Matrix: Display RGB to XYZ transform for pixel n
:=bxyzn*MJn

DTin=Matrix: XYZ to Display RGB transform for pixel n
:=Inverse of DTn

Wpeakn=Vector: PWM drive factors for pixel to produce white point at its max possible Y for pixel n
:=(RYn/bYn)/max(RYn/bYn)

Ypeakn=Scalar: Luminance of pixel n driven at Wpeakn

Wn=Vector: PWM scaling factors that produce target white point for pixel n
: This is used to scale the PWM output at display time

WMax=Scalar: Max final value for any W component for good new panel
:=1−(HeadRoom/100)

BadWDif=Boolean: True if pixel's white balance ratio is excessive
:=max(Wpeak)−min(Wpeak)>MaxWDif

BadWMax=Boolean: True if pixel is under powered
:=max(W)>WMax
   Self Calibration

PDkn=Scalar: Photo Detector Reading for blacK for pixel n

PDn=Vector: Photo Detector Readings for R,G and B for pixel n

PDcn=Scalar: element c of PD for pixel n

Mn=Vector: Photo Detector Measurements for R,G and B for pixel n
: Mn=PDn−PDkn

Mcn=Scalar: element c of Mn

Yn=Vector: Luminances of each primary for pixel n
:=Mn.*PDGainn

Wpeakn=Vector: PWM drive factors for pixel n to produce white point at its max possible Yn
:=(RYn/Yn)/max(RYn/Yn)

Ypeakn=Scalar: Luminance of pixel driven at Wpeakn for pixel n
:=sum(Wpeakn.*Yn)

Wn=Vector: PWM scaling factors that produce target white point for pixel n
:=Wpeakn*(WhitePointY/Ypeakn)
: Replaces Wn computed during factory calibration

BadPix=Boolean: True if pixel is marked bad during self calibration
:=max(Wn)>1
   Color Mapping

ST=Matrix: Source RGB to XYZ transform
: Computed for source color space information
: Constant for all pixels

Tn=Matrix: Per Pixel Source RGB to Display RGB transform for pixel n
:=ST*DTi

DTin=Matrix: DTi matrix for pixel n

Display

SI=Image: Source Image in Source Linear RGB

DI=Image Destination PWM drive to display image
: DIn=Wn.*(Tn*SIn)

Tn=Matrix: T transform for pixel n

Wn=Vector: W vector for pixel n

DIn=Vector: Display PWM output for pixel n

Snapshot

SNAP=Image: Image showing black and white snapshot of current display
:=PDsn−PDkn

SNAPn=Scalar: Measurement value for snapshot pixel n

PDsn=Scalar: Photo Detector Value of pixel n during snapshot

PDkn=Scalar: Photo Detector Value of black pixel n during last Display Black,
:Self Calibration, or Baseline

### CONCLUSION

There has thus been described a self-contained LED area illumination source/video display comprised of a plurality of individual groups/pixels (pixels) of LEDs in which (a) each pixel is capable of forming the smallest area of the source/display and includes a plurality of LEDs with the LED(s) representing a discrete or primary color being arranged to be separately energized so that by energizing one or more LEDs any color can be emitted from the pixel and (b) at least one light sensor/photodetector (detector) arranged to provide a measure of the intensity of the emitted light from each LED. In the embodiments of FIGS. 3-10 a separate photodetector is associated with each pixel or with each LED in FIGS. 5-10 where only one LED DIE and one photodetector is contained within a single envelope.

It is to be noted that the illumination source/video display may be constructed so that one detector is associated with more than one pixel as long as the detector is capable of separately measuring the emitted light from each LED in the grouping. For self-calibration purposes it is only necessary to measure the change in the luminous intensity of the emitted light from each of the LEDs over time.

It is also to be noted that while each LED pixel is fixed in space on the display, the display can be operated to arbitrarily assign contiguous primary LEDs, e.g., red, blue and green, to create a perceived point on the display that does not coincide with a stationary pixel position. In other words, one or more primary color LEDs may be shared with one or more primary color LEDs of adjacent pixels to create a perceived display point. This operational technique is commonly referred to as tiling and is sometimes useful in increasing the resolution of the displayed image with respect to the source image.

It is also to be noted that the display can be operated to provide the black and snapshot optional features illustrated in FIGS. 20 and 21 with fewer detectors than pixels with an obvious loss of resolution.

The present invention is not limited to the disclosed embodiments or methods of operation and modifications as well as enhanced uses will become obvious to those skilled in the art without involving any departure from the spirit and scope of the invention as defined by the appended claims.

1. An LED area illumination source for emitting light of a desired color comprising:
a) a plurality of individual groups of LEDs with each group representing a finite area of the source and capable of replicating all of the colors of the source;
b) each individual group including a plurality of LEDs with the LED(s) representing a discrete color being arranged to be separately energized so that by simultaneously energizing one or more of the LEDs a desired color and luminous intensity of light can be emitted from the group; and
c) at least one light sensor capable of providing a separate output signal representative of a measure of the luminous intensity of the emitted light from each LED.

2. The illumination source of claim 1 wherein said at least one light sensor comprises a single light sensor associated with all of the LEDs in an individual group.

3. The illumination source of claim 1 wherein said at least one light sensor comprises a light sensor associated with each LED.

4. The invention of claim 1 wherein the illumination source is a display arranged to form an image to be viewed by an observer or observers and each individual group of LEDs is capable of representing the smallest perceived increment of the displayed image.

5. A method of determining the degradation of the LED(s) representative of each color of the illumination source of claim 1 comprising:
a) energizing the LEDs at time to to provide a separate light sensor output signal for each LED(s) representative of a discrete color for each group with each signal bearing a predetermined relationship to the energization level of the respective LED(s); and
b) at a subsequent time tₙ energizing the LEDs to provide a separate output signal for each LED(s) representative of a discrete color of each group with the output signals bearing a predetermined relationship to the energization level of the respective LED(s);
c) reading each output signal obtained during the energization at time tₙ; and
d) comparing the sensor output signals associated with each LED(s) representing a discrete color of each group obtained at tₙ with the corresponding output signals obtained at tₒ.

6. The method of claim 5 wherein the energization levels at times tₒ and tₙ are set at given percentages of the total available energization.

7. The method of claim 6 wherein the energization level is the maximum.

8. The method of claim 5 wherein PWM is used to energize the LEDs with 100% ON TIME being the maximum.

9. The method of claim 5 wherein the illumination source is a video display for forming an image to be viewed by an observer or observers and further including characterizing the display at time to by varying the energization of each LED(s) representing a discrete color of each group to achieve the desired light output for the display, the light sensor output signals stored at to further bearing a predetermined relationship to the light emitted by the respective LED(s) and subsequent to the comparison step controlling the energization of each LED(s) representative of a discrete color for each LED group to substantially restore the desired light output achieved at time tₒ and storing a signal representative of the energization levels required to restore the desired light output.

10. The method of claim 9 further including at time tₙ measuring the difference between the sensor output signals at time tₙ with corresponding output signals at time tₒ to provide an error signal representative of the difference.

11. The method of claim 10 further including reducing the error signals to an acceptable amount.

12. The method of claim 11 further including storing the energization signal for each LED(s) representing a discrete color for each group required to reduce the error signal to the acceptable amount for subsequent use.

13. The method of claim 10 further including comparing the error signal with a predetermined maximum value representing an LED or detector failure and storing a failure signal identifying the LED or group.

14. A colored video display for directing light forming an image in an XY plane to be viewed by an observer or observers comprising:
a) a plurality of individual pixels with each pixel being capable of representing the smallest increment or perceived point of the image;
b) each pixel comprising a plurality of LEDs, the LEDs representing each primary color being arranged to be separately energized so that by simultaneously energizing one or more of the LEDs of a pixel any desired color can be emitted from the pixel; and
c) at least one light sensor mounted within the display for providing a separate output representing a measure of light emitted by each primary color LED within each pixel.

15. The display of claim 14 wherein said at least one light sensor comprises a light sensor associated with each pixel.

16. The display of claim 14 wherein said at least one light sensor comprises a light sensor individually associated with each LED.

17. A method of operating the video display of claim 14 comprising:
a) characterizing the display at time tₒ by sequentially energizing each primary color LED(s) of each pixel to achieve the desired output for the display and storing the energization level for each LED necessary to achieve the desired output at the time of characterization;
b) at the time tₒ of characterization reading and storing the outputs of said at least one light sensor so that the outputs associated with the primary color LED(s) bears a predetermined relationship with the light emitted from and the energization of the associated LED(s)
c) at a time tₙ subsequent to characterization separately energizing each primary LED(s) of each pixel with a predetermined level of energization; and
d) comparing the corresponding sensor outputs obtained at times tₒ and tₙ.

18. The method of claim 17 further including controlling the energization of each primary color LED(s) of each pixel to restore the luminous intensity of each primary color LED(s) to the value achieved at tₒ.

19. A colored video display for directing light forming an image to be observed by an observer or observers comprising:
a) an array of pixels with each pixel capable of representing a perceived point of the displayed image;
b) each pixel comprised of a plurality of LEDs, the LED(s) representing a discrete color being arranged to be separately energized so that by energizing one or more of the LEDs any desired color can be emitted from the pixel;
c) the display being arranged to internally reflect a portion of the light emitted from each LED; and
d) at least one light sensor arranged to receive a portion of the internally reflected light from each LED.

20. The video display of claim 19 wherein said at least one light sensor comprises a light sensor associated with each LED.

21. The video display of claim 19 wherein said at least one light sensor comprises a single light sensor associated with each pixel.

22. A method of calibrating the display of claim 19 comprising:
a) at time tₒ energizing the LEDs to achieve the desired light output and further energizing each LED(s) of each pixel representing each discrete color and reading a measure of light emitted by each of said LEDs with the measurement bearing a predetermined relationship to the intensity of the emitted light and the energization level of the respective LED(s);
b) at time tₙ, subsequent to tₒ, energizing each LED(s) representing a discrete color of each pixel and measuring the light output of each of said LED(s) with the measurement bearing a predetermined relationship to the energization level of said LED(s);
c) comparing the measurement of light output of each LED(s) representing a discrete color of each pixel at tₙ with the corresponding measurement of the light output at tₒ; and
d) controlling the energization of each LED(s) representing a discrete color of each group to substantially restore said desired output achieved at time tₒ.

23. A method of operating the display of claims 14 or 19 further including the step of measuring the output of said at least one light sensor associated with each LED(s) representing a discrete color of each pixel while the display is forming the image to provide a snap shot of the displayed image.

24. A method of operating the display of claims 14 or 19 wherein said at least one light sensor is arranged to provide an output on a pixel by pixel basis representative of the ambient light falling on the display.

25. A method of determining the degradation of the LED(s) representative of each color of the illumination source of claim 2 comprising:
a) energizing the LEDs at time tₒ to provide a separate light sensor output signal for each LED(s) representative of a discrete color for each group with each signal bearing a predetermined relationship to the energization level of the respective LED(s); and
b) at a subsequent time tₙ energizing the LEDs to provide a separate output signal for each LED(s) representative of a discrete color of each group with the output signals bearing a predetermined relationship to the energization level of the respective LED(s);
c) reading each output signal obtained during the energization at time tₙ; and
d) comparing the sensor output signals associated with each LED(s) representing a discrete color of each group obtained at tₙ with the corresponding output signals obtained at tₒ.

26. The method of claim 25 wherein the energization levels at times tₒ and tₙ are set at given percentages of the total available energization.

27. The method of claim 26 wherein the energization level is the maximum.

28. The method of claim 25 wherein PWM is used to energize the LEDs with 100% ON TIME being the maximum.

29. The method of claim 25 wherein the illumination source is a video display for forming an image to be viewed by an observer or observers and further including characterizing the display at time tₒ by varying the energization of each LED(s) representing a discrete color of each group to achieve the desired light output for the display, the light sensor output signals stored at tₒ further bearing a predetermined relationship to the light emitted by the respective LED(s) and subsequent to the comparison step controlling the energization of each LED(s) representative of a discrete color for each LED group to substantially restore the desired light output achieved at time tₒ and storing a signal representative of the energization levels required to restore the desired light output.

30. The method of claim 29 further including at time tₙ measuring the difference between the sensor output signals at time tₙ with corresponding output signals at time tₒ to provide an error signal representative of the difference.

31. The method of claim 30 further including reducing the error signals to an acceptable amount.

32. The method of claim 31 further including storing the energization signal for each LED(s) representing a discrete color for each group required to reduce the error signal to the acceptable amount for subsequent use.

33. The method of claim 30 further including comparing the error signal with a predetermined maximum value representing an LED or detector failure and storing a failure signal identifying the LED or group.

34. A method of determining the degradation of the LED(s) representative of each color of the illumination source of claim 3 comprising:
a) energizing the LEDs at time tₒ to provide a separate light sensor output signal for each LED(s) representative of a discrete color for each group with each signal bearing a predetermined relationship to the energization level of the respective LED(s); and
b) at a subsequent time tₙ energizing the LEDs to provide a separate output signal for each LED(s) representative of a discrete color of each group with the output signals bearing a predetermined relationship to the energization level of the respective LED(s);
c) reading each output signal obtained during the energization at time tₙ; and
d) comparing the sensor output signals associated with each LED(s) representing a discrete color of each group obtained at tₙ with the corresponding output signals obtained at tₒ.

35. The method of claim 34 wherein the energization levels at times tₒ and tₙ are set at given percentages of the total available energization.

36. The method of claim 35 wherein the energization level is the maximum.

37. The method of claim 34 wherein PWM is used to energize the LEDs with 100% ON TIME being the maximum.

38. The method of claim 34 wherein the illumination source is a video display for forming an image to be viewed by an observer or observers and further including characterizing the display at time tₒ by varying the energization of each LED(s) representing a discrete color of each group to achieve the desired light output for the display, the light sensor output signals stored at tₒ further bearing a predetermined relationship to the light emitted by the respective LED(s) and subsequent to the comparison step controlling the energization of each LED(s) representative of a discrete color for each LED group to substantially restore the desired light output achieved at time tₒ and storing a signal representative of the energization levels required to restore the desired light output.

39. The method of claim 38 further including at time tₙ measuring the difference between the sensor output signals at time tₙ with corresponding output signals at time tₒ to provide an error signal representative of the difference.

40. The method of claim 39 further including reducing the error signals to an acceptable amount.

41. The method of claim 40 further including storing the energization signal for each LED(s) representing a discrete color for each group required to reduce the error signal to the acceptable amount for subsequent use.

42. The method of claim 41 further including comparing the error signal with a predetermined maximum value representing an LED or detector failure and storing a failure signal identifying the LED or group.
